(19) United States
(12) Patent Application Publication
(10) Pub. No.: US 2013/0260006 A1
(43) Pub. Date: Oct. 3, 2013

(54) Composition for Cola Beverage with Enhanced Flavor and Texture

(71) Applicant: Peter M. Wells, Shorewood, WI (US)

(72) Inventor: Peter M. Wells, Shorewood, WI (US)

(21) Appl. No.: 13/852,192

(22) Filed: Mar. 28, 2013

Related U.S. Application Data
(60) Provisional application No. 61/617,475, filed on Mar. 29, 2012.

(51) Int. Cl. A23L 2/56

(52) U.S. Cl. CPC A23L 2/56
USPC 426/598

(57) ABSTRACT

A composition for a cola beverage with enhanced flavor and texture combines a carbonated cola and a cola enhancing mixture for an enhanced cola beverage. The cola enhancing mixture may be added to existing cola beverages, or the present invention may be manufactured and distributed as a unit. The cola enhancing mixture includes flavoring syrup, a high-fat liquid dairy product, cinnamon powder, caffeine, and chia powder. The combination of the cola enhancing mixture with the cola beverage produces a unique taste and texture that is a dramatic enhancement over a standard cola beverage.

The current application claims a priority to the U.S. Provisional Patent application Ser. No. 61/617,475 filed on Mar. 29, 2012.

### FIELD OF THE INVENTION

The present invention relates generally to beverages. More particularly, the present invention is a formula for a beverage additive that is used for enhancing a carbonated cola drink.

### BACKGROUND OF THE INVENTION

Water has always been known as an important life-sustaining drink to humans and is essential to the survival of virtually all known organisms. Excluding fat, the human body is composed of approximately 70 percent water by mass, and water is a crucial component of metabolic processes and serves as a solvent for many bodily solutes. Various health authorities recommend that the average person drink approximately 2 to 3 liters of water per day, though the daily water requirement will vary among individuals, depending on the condition of the subject, the amount of physical exercise, and the environmental temperature and humidity, among other factors. In general, an individual's thirst provides an adequate guide for how much water they require rather than a specific, fixed quantity.

Many other drinks, or beverages, besides water may be consumed by humans, providing various nutrients, flavors, stimulants, or other factors that may be processed by the human body. There are many groups for drinks, which can be divided into various groups such as plain water, alcoholic drinks, non alcoholic drinks, soft drinks, fruit or vegetable juices, and hot drinks. In addition to fulfilling a basic need, drinks form part of the culture of human society. For example, in many countries, drinking alcoholic beverages in a local bar or pub is a cultural tradition. Many people also choose a variety of different drinks to pair with meals.

A soft drink (also called soda, pop, coke, soda pop, fizzy drink, or carbonated beverage) is a beverage that typically contains water, usually a sweetener, and usually a flavoring agent. Soft drinks are called “soft” in contrast to “hard” drinks, or alcoholic beverages. The water in a soft drink is often, but not always, carbonated, which means that carbon dioxide gas under pressure has been dissolved into the water, causing the water to become effervescent. Soft drinks may also contain caffeine, colorings, preservatives and other ingredients.

One of the most common soft drinks is cola. Cola is a carbonated beverage that was originally flavored and caffeinated by the kola nut, as well as by vanilla and other ingredients. However, most colas now use other flavoring and caffeinating ingredients with a similar taste. Cola became popular worldwide after the druggist John Pemberton invented Coca-Cola in 1886.

Some people may have an inclination to strong flavors, and so think ordinary soft drinks are bland and simple tasting. Currently, there exist few effective options for enhancing the flavor of soft drinks, in particular cola based products. It is therefore an object of the present invention to provide a formula that is used not only for enhancing carbonated cola soft drinks, but transforming a cola drink into a rich, modern, and luxurious tasting alternative to simple cola.

### BRIEF DESCRIPTION OF THE DRAWINGS

FIG. 1 is a view of the components of the present invention.

### DETAIL DESCRIPTIONS OF THE INVENTION

All illustrations of the drawings are for the purpose of describing selected versions of the present invention and are not intended to limit the scope of the present invention.

The present invention is a recipe for an enhanced cola beverage. The present invention comprises a carbonated cola and a cola enhancing mixture that, when mixed in the prescribed formula combinations with the carbonated cola, provides a more pleasing, flavorful, and luxurious beverage alternative to simple cola. The present invention is preferably known as “Impulse Luxury Soda”, or ILS. The cola enhancing mixture is preferably known as “ILS mixture.” To create the present invention, the ILS mixture is combined with ice in a tall (16 ounce) glass, and the carbonated cola is used to fill the glass. The resulting mixture is light brown in color, slightly foamy, and provides a unique taste that dramatically enhances the base cola drink. When bottled, the ILS mixture is expected to have a shelf life of four months. The ILS mixture is expected to have a shelf life of longer than four months if refrigerated.

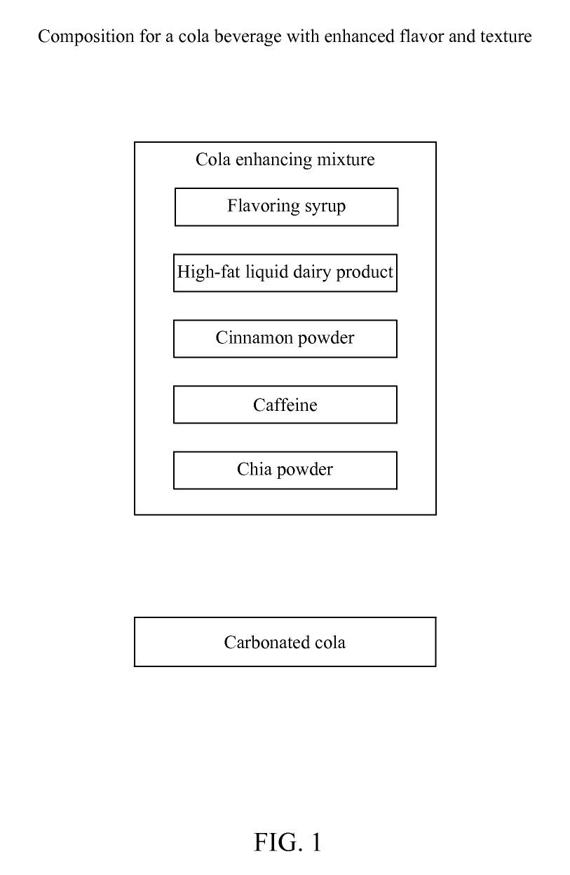

In reference to FIG. 1, the present invention comprises a carbonated cola and a cola enhancing mixture. The cola enhancing mixture comprises flavoring syrup, a high-fat liquid dairy product, cinnamon powder, caffeine, and chia powder.

The carbonated cola is any existing or future cola product. A cola is a carbonated beverage that generally contains caramel color, caffeine, sweeteners such as sugar or high fructose corn syrup, and flavor derived from or similar to that of the kola nut. In the preferred embodiment, the present invention comprises about 12 fluid ounces of carbonated cola. In alternate embodiments, the present invention comprises slightly less or more carbonated cola, with the carbonated cola preferably being present at a range between 10 and 14 fluid ounces, or at a range between 60 and 80 percent weight of the present invention.

In the preferred embodiment of the present invention, the flavoring syrup is sweet chocolate syrup. The flavoring syrup may be any brand of sweet chocolate syrup, or the flavoring syrup may be made from primary ingredients using sugar, water, and cocoa powder. The preferred embodiment comprises about 1.5 fluid ounces of flavoring syrup. In alternate embodiments, the flavoring syrup is present at a range between 1 and 2.5 fluid ounces, or at a range between 15 and 30 percent weight of the present invention.

In the preferred embodiment of the present invention, the high-fat liquid dairy product is standard half and half cream. The half and half cream is a common liquid comprised of half milk and half cream with approximately 10-20 percent butterfat by weight. Cream is a dairy product that is composed of a higher-butterfat layer skimmed from the top of milk before homogenization. In an alternate embodiment, the high-fat liquid dairy product is created by mixing milk and liquid butter together. In this embodiment, less butter than milk should be used. In the preferred embodiment, the present invention comprises about 1.25 fluid ounces of the high-fat liquid dairy product. In alternate embodiments, the high-fat liquid dairy product is present in the present invention at a range between 5 and 10 percent weight, or at a range between 1 and 1.5 fluid ounces.

The cinnamon powder provides cinnamon flavor to the present invention, as well as providing antioxidant properties. In the preferred embodiment, the present invention comprises about 2 teaspoons of cinnamon powder. In alternate embodiments, the cinnamon powder is present at a range between 1 and 6 teaspoons, or at a range between 0.4 and 2.5 percent weight of the present invention. The cinnamon powder is preferably of the orange cinnamon powder variety.

The caffeine is a well-known substance that acts as a central nervous system stimulant in humans, temporarily warding off drowsiness and enhancing alertness. The caffeine is identified with the chemical abstract service (CAS) registry number of 58-08-2. In the preferred embodiment, the present invention comprises about 0.2 grams of caffeine. In alternate embodiments, the caffeine is present at a range between 0.0 and 0.3 grams, or at a range between 0.0 and 0.04 percent weight of the present invention.

The chia powder is pulverized from the salvia hispanica plant, commonly known as chia, which is a species of flowering plant in the mint family native to central and southern Mexico and Guatemala. Seeds of the chia plant are rich in omega-3 fatty acids, as well as antioxidants and other nutrients. In the preferred embodiment, the present invention comprises 0.5 teaspoons of chia powder. In alternate embodiments, the chia powder is present at a range between 0.0 and 1 teaspoon, or at a range between 0.0 and 0.04 percent weight of the present invention.

In the preferred embodiment of the present invention, the cola enhancing mixture is created separately from the carbonated cola. In the preferred embodiment, to create the present invention, a mixing container is partially or completely filled with ice. The carbonated cola and the cola enhancing mixture are added to the mixing container and shaken or stirred to thoroughly mix the ingredients. The present invention is then ready to be served. This embodiment is suited for use in a restaurant, social setting or in one's home. In an alternate embodiment, the present invention may be manufactured with all ingredients simultaneously and packaged into a disposable container in a similar manner to existing manufactured beverages.

Although the invention has been explained in relation to its preferred embodiment, it is to be understood that many other possible modifications and variations can be made without departing from the spirit and scope of the invention as hereinafter claimed.

What is claimed is:

1. A composition for a cola beverage with enhanced flavor and texture comprises:
a.) carbonated cola;
b.) a cola enhancing mixture:
flavoring syrup,
a high-fat liquid dairy product,
cinnamon powder,
caffeine, and
chia powder;
the carbonated cola being present at a range between 60-80 percent weight;
the flavoring syrup being present at a range between 15-30 percent weight;
the high-fat liquid dairy product being present at a range between 5-10 percent weight;
the cinnamon powder being present at a range between 0.4-2.5 percent weight;
the caffeine being present at a range between 0.0-0.04 percent weight; and
the chia powder being present at a range between 0.0-0.04 percent weight.

2. The composition for a cola beverage with enhanced flavor and texture as claimed in claim 1, wherein the flavoring syrup is sweet chocolate syrup.

3. The composition for a cola beverage with enhanced flavor and texture as claimed in claim 1,
wherein the high-fat liquid dairy product is half and half cream; and
wherein the half and half cream comprises 10-20 percent butterfat by weight.

4. The composition for a cola beverage with enhanced flavor and texture as claimed in claim 1, wherein the high-fat liquid dairy product is a mixture of milk and liquid butter.

5. The composition for a cola beverage with enhanced flavor and texture as claimed in claim 1, wherein the cinnamon powder is specifically orange cinnamon powder.

6. A composition for a cola beverage with enhanced flavor and texture comprises:
a.) carbonated cola;
b.) a cola enhancing mixture:
flavoring syrup,
a high-fat liquid dairy product,
cinnamon powder,
caffeine, and
chia powder;
the carbonated cola being present at a range between 10-14 fluid ounces;
the flavoring syrup being present at a range between 1-2.5 fluid ounces;
the high-fat liquid dairy product being present at a range between 1-1.5 fluid ounces;
the cinnamon powder being present at a range between 1-6 teaspoons;
the caffeine being present at a range between 0.0-0.3 grams; and
the chia powder being present at a range between 0.0-1 teaspoons.

7. The composition for a cola beverage with enhanced flavor and texture as claimed in claim 6, wherein the flavoring syrup is sweet chocolate syrup.

8. The composition for a cola beverage with enhanced flavor and texture as claimed in claim 6,
wherein the high-fat liquid dairy product is half and half cream; and
wherein the half and half cream comprises 10-20 percent butterfat by weight.

9. The composition for a cola beverage with enhanced flavor and texture as claimed in claim 6, wherein the high-fat liquid dairy product is a mixture of milk and liquid butter.

10. The composition for a cola beverage with enhanced flavor and texture as claimed in claim 6, wherein the cinnamon powder is specifically orange cinnamon powder.

11. A composition for a cola beverage with enhanced flavor and texture comprises:
a.) carbonated cola; and
b.) a cola enhancing mixture:
flavoring syrup,
a high-fat liquid dairy product,
cinnamon powder,
caffeine, and
chia powder.

12. The composition for a cola beverage with enhanced flavor and texture as claimed in claim 11 comprises about 12 fluid ounces of carbonated cola.

13. The composition for a cola beverage with enhanced flavor and texture as claimed in claim 11 comprises about 1.5 fluid ounces of flavoring syrup, wherein the flavoring syrup is sweet chocolate syrup.

14. The composition for a cola beverage with enhanced flavor and texture as claimed in claim 11 comprises about 1.25 fluid ounces of high-fat liquid dairy product, wherein the high-fat liquid dairy product is half and half cream.

15. The composition for a cola beverage with enhanced flavor and texture as claimed in claim 11 comprises about 2 teaspoons of cinnamon powder, wherein the cinnamon powder is specifically orange cinnamon powder.

16. The composition for a cola beverage with enhanced flavor and texture as claimed in claim 11 comprises about 0.2 grams caffeine.

17. The composition for a cola beverage with enhanced flavor and texture as claimed in claim 11 comprises about 0.5 teaspoons of chia powder.
